(19) United States
(12) Patent Application Publication
(10) Pub. No.: US 2005/0161852 A1
(43) Pub. Date: Jul. 28, 2005

(54) Bamboo chip treatment and products

(76) Inventors: Emil Guy Decker, Portland, OR (US); Bernard Reno Joeson, Portland, OR (US)

Correspondence Address: EMIL GUY DECKER, 404 NE 69TH AVENUE, PORTLAND, OR, 97213, US

(21) Appl. No.: 10/764,998

(22) Filed: Jan. 27, 2004

(51) Int. Cl. B32B 31/00

(52) U.S. Cl. 264/109; 162/94; 156/62.2; 156/296

(57) ABSTRACT

Thin elongated bamboo chips are produced and then are softened and dried. The softening of the chips reduces void spaces which uses less glue and produces stronger members. The chips are then joined together with glue under pressure to form a bamboo board. By varying the depth and length of the chip form, the member produced can form a board, chipboard, beams, or columns of any size. Additional boards may be produced and glued together to form a larger board, beam, or column. Several chipboard layers fabricated in large sheets and glued together will form ‘multi-ply bamboo’, a bamboo substitute for plywood. Once cured, the member is kiln dried and sealed for moisture. The resulting bamboo member's strength and geometrical form is stable and consistent enough to be used as a structural grade member for frames, homes, buildings, and furniture.

### STATEMENT REGARDING FEDERALLY SPONSORED RESEARCH OR DEVELOPMENT

There was not any federally sponsored research or development for this patent.

### BACKGROUND OF THE INVENTION

Since bamboo trees and wood trees are not of the same botanical species, the methods of cultivation, harvesting and curing of bamboo trees differ widely from that of wood trees; so are the characters of its fiber, its color, and its grain textures. In addition, the manufacturing methods and physical or chemical treatments of bamboo also differ greatly from that of woods, therefore all manufactured wood boards such as plywood, laminate of any material woods, wafer woods, and particle boards should not be used to compare with this invention.

Bamboo trees are normally not suitable for the production of bamboo boards or plywood. Since bamboo tree trunks are hollow, they cannot be made into bamboo boards. In addition, bamboo tree trunks have relatively small diameters even when the trees are fully mature, and so the standard process of manufacturing plywood or other wood products cannot be applied to bamboo logs with practicality.

Bamboo fibers are stiffer and stronger than most wood fibers, so bamboo boards should have a strength to weight ratio greater than that of boards made from most woods. More importantly, bamboo trees grow to full maturity in only 3 to 6 years while wood trees, even the fastest growing ones, would take 15 to 30 years. This very favorable growth rate of bamboo trees would present a significant solution to the possible shortage of available wood caused by both the increasing demand for wood and the gradual depletion of sizeable wood trees, a shortage which can be alleviated through the successful use of bamboo.

No patents using thin bamboo chips to make boards, columns or beams have been issued.

The existing patents all use long bamboo strips, often the length of the entire bamboo stalk, which can be 20′ or longer. U.S. Pat. No. 4,810,551, by Chu, featured fabricating small boards from strips of bamboo however, the large size and random orientation these strips resulted in large void spaces, and furthermore, the large spaces resulted in poor aesthetic appearance, higher glue costs, less strength, and low dependability of performance. U.S. Pat. No. 5,543,197, by Plaehn, made beams only, out bamboo stalk strips only; however, the large size and random radial orientation these random shaped strips resulted in large void spaces, and furthermore, the large spaces resulted in poor aesthetic appearance, higher glue costs, less strength, and low dependability of performance. U.S. Pat. No. 5,976,644, by Sanaee, featured the treatment of large strips of entire bamboo shoots and the fabrication of small boards from rectangular strips of treated bamboo however, the cost and labor required to cut, plane, shape, and place these strips is also quite high.

Several patents on the manufacture of bamboo boards and beams have been issued but all the previous products are either too small to use in structural members, are too labor intensive, or have large void spaces that cause instability and undependable strength.

The use of the softening process on the thin chips allows the chips to easily bend. The softened chips, when compressed during the gluing stage, bend to conform around each other, which reduces void spaces between adjacent chips, uses less glue, and increases bond between the chips. Greater bond leads to stronger members. In addition, the softened chips conform to the board form, making the final product flatter. The softening, drying, gluing, and sealing of bamboo chips that are detailed in this invention are required to produce inexpensive bamboo boards, beams, and columns that are consistently strong, stable, flat and plumb, and don't warp.

Bamboo chips as short as 1½″ in length can be used in this invention, therefore small bamboo scraps or recycled bamboo shoots, which would normally be refuse, can be utilized; thus making a very inexpensive product.

Consistently stable bamboo members are required so that the testing and standardization of members can be performed and established into dependable tables of allowable loads. Standard load tables will allow engineers and building officials to use bamboo as structurally rated members for residential, commercial, and industrial buildings and frames. Also, larger bamboo furniture pieces of higher quality will be possible with this method.

Stable, standardized bamboo products will increase the safety of its use as a structural member.

### BRIEF SUMMARY OF THE INVENTION

Thin elongated bamboo chips are produced by two methods depending on the final product quality required. For low quality, one may run the bamboo shoot through a rotating blade machine to produce thin chips. For higher quality grade members, the bamboo shoot may be cut into pieces of under 6″ in length and split into chips of ⅛″ maximum thickness. The longer chips work best for thicker members, and shorter chips work best for thinner members.

These chips then softened through any one of the following methods: oxidation, fermentation,, basic chemical reaction, or bacterial action, or boiling. The resulting softened chips are then dried, coated with glue, and then the chip fibers are generally oriented longitudinally parallel to the length of the beam and laid on top of each other in a random overlapping manner. Because the chips are thin, the glue is evenly distributed, and void spaces are small. When the chips are joined together with glue under pressure in a form, the result is that there is great coherence between and within the chips to form a bamboo board. By varying the depth and length of the chip form, the member produced can form a board, chipboard, beams, or columns of any size. Or, once this first board is complete, additional boards may be produced and glued together under pressure in a form, with the result that there is great coherence between the board layers to form a larger: board, chipboard, beam or column. Thus, various board dimensions can be fabricated to form bamboo beams and columns in any dimension by gluing successive members together.

If several chipboard layers are fabricated in large sheets and glued together under pressure into a form, one can form ‘multi-ply bamboo’, which is a bamboo substitute for plywood. Once the glue is cured, the resulting bamboo member is kiln dried to below 12% humidity and sealed for moisture. Since this board, beam, column, chipboard, or multi-ply bamboo is sealed, dried, and has had its chips softened, the strength will be consistent throughout the member and the geometrical form stable, such that it may be used in furniture or as structural grade members for frames and in residential, commercial, and industrial buildings.

### BRIEF DESCRIPTION OF THE SEVERAL VIEWS ON DRAWING PAGES 1-5

FIG. 1 end view of the bamboo shoot.

FIG. 2 vertical and horizontal blades of a bamboo splitting tool

FIG. 3 end view of the shoot being split vertically and horizontally

FIG. 4 radial splitting tool

FIG. 5 end view of the shoot splitting radially

FIG. 6 profiles of the thickness and width of the final chips

FIG. 7 profiles of the thickness and width of smaller final chips.

FIG. 8 different size bamboo chips

FIG. 9 chips generally oriented longitudinally parallel in a random overlapping manner

FIG. 10 isometric view of a board formed with chips

FIG. 11 end view of a board formed that is thinner than FIG. 10, with chip strands generally oriented parallel to the board length

FIG. 12 end view with chip strands generally oriented perpendicular to the board length

FIG. 13 bamboo end view board, column, or beam formed by three layers of bamboo, with chip strands generally oriented parallel to the board length to form a larger member

FIG. 14 bamboo end view board, column, or beam formed by three layers of bamboo, with the exterior boards' chip strands generally oriented parallel to the board length, with the interior boards' chip strands generally oriented perpendicular to the board length

FIG. 15 bamboo end view board, column, or beam formed by many layers of bamboo, with chip strands generally oriented parallel to the board length to form a larger member

FIG. 16 bamboo end view board, column, or beam formed by many layers of bamboo, with the first boards' chip strands generally oriented parallel to the board length, the second boards' chip strands generally oriented perpendicular to the board length, the next boards' chip strands generally oriented parallel to the board length, and the remaining boards alternating such that each board has its chip orientation perpendicular to the next to form a larger member

FIG. 17 bamboo chipboard end view with the chip strands generally oriented in parallel

FIG. 18 bamboo chipboard end view with the chip strands generally oriented perpendicular

FIG. 19 multi-ply bamboo end view formed by many layers of chipboards, with chip strands generally oriented parallel to the board length to form a larger member

FIG. 20 multi-ply bamboo end view formed by many layers of chipboards, with the first boards' chip strands generally oriented parallel to the board length, the second boards' chip strands generally oriented perpendicular to the board length, the next boards' chip strands generally oriented parallel to the board length, and the remaining boards alternating such that each board has its chip orientation perpendicular to the next to form a larger member.

### DETAILED DESCRIPTION OF THE INVENTION

Thin elongated bamboo chips are produced by two methods depending on the quality required. For low quality, one may run the bamboo shoot through a rotating blade machine to produce thin chips. FIG. 1 shows an end view of the bamboo shoot.

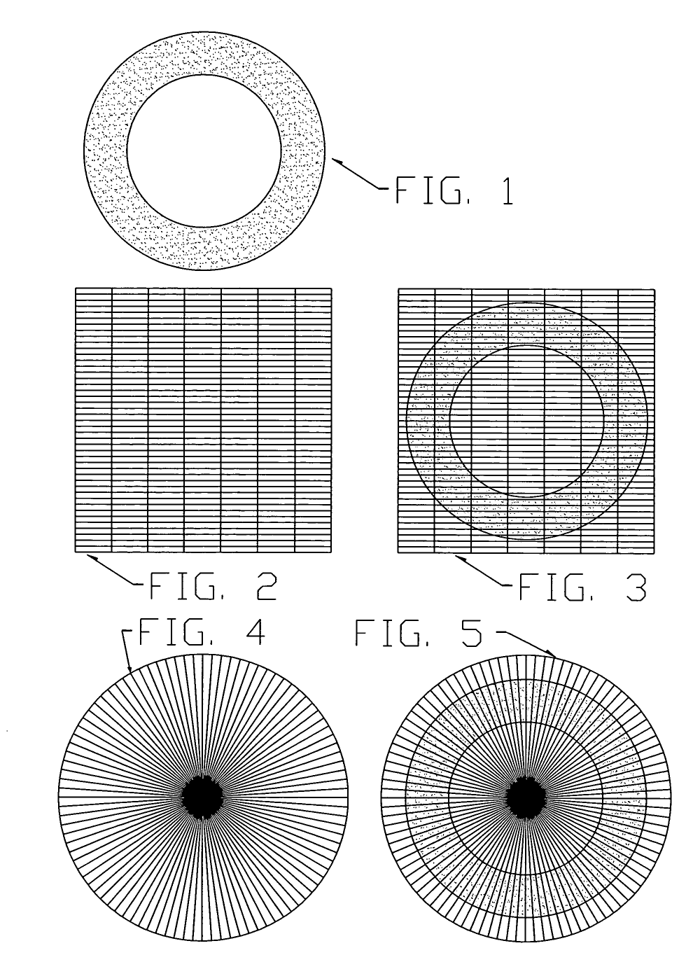

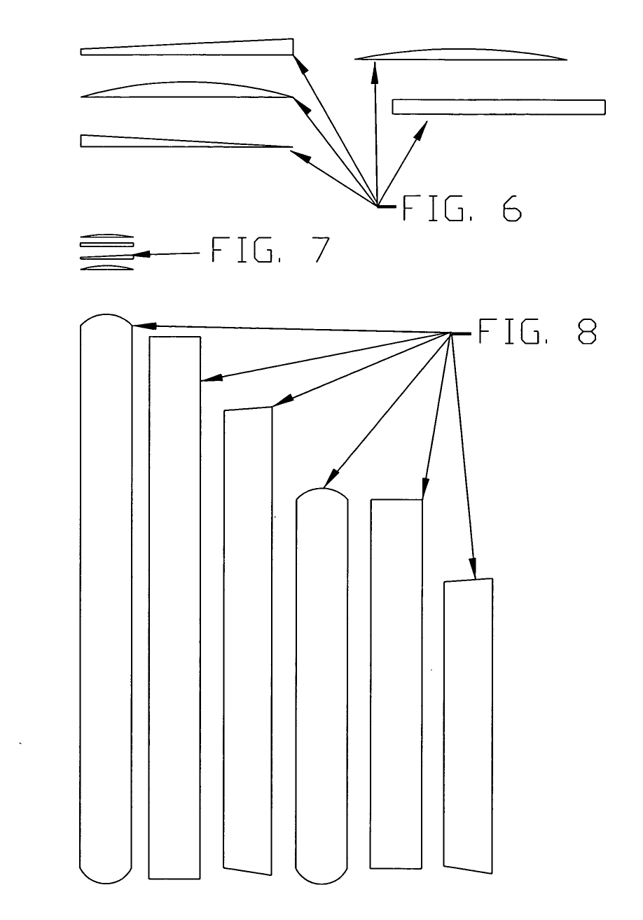

For higher quality grade beams, the bamboo shoot may be cut into pieces of under 6″ in length. Then one splits the shoot lengthways several times parallel to its length to produce thin bamboo chips of under ⅛″ in thickness, although chips of 1/16″ in thickness produce the best results. FIG. 2, shows the vertical and horizontal blades of a bamboo splitting tool. FIG. 3 shows an end view of the shoot being split vertically and horizontally on the tool where the maximum width used is ¾″. FIG. 4 shows a radial splitting tool. FIG. 5 shows the tool splitting end view of the shoot radially where the chip width is the thickness of the bamboo shoot wall. FIGS. 6 and 7 shows profiles of the thickness and width of the final chips. The longer chips work best for thicker members, and shorter chips work best for thinner boards; the different size chips are illustrated in FIG. 8.

These chips are then softened through any one of the following methods: oxidation, fermentation, basic chemical reaction, or bacterial action, or boiling. The choice of method is based on the finished look and color required.

The chips must be softened to make them easily bendable. Only softened chips will bend under pressure to reduce voids.

Oxidation can produce a bleached look. Using a diluted solution of under 10% chlorine for several hours, depending upon the size and type of chips used, soften the bamboo. However, if the chips are left in too long, the chlorine will break down the fibers themselves and weaken the final product. The chips must be soaked and rinsed to remove the residual chlorine.

Fermentation and bacterial actions are inexpensive, but take several days. This is performed by combining the chips with as little water as will cover the chips, and then boiling the chips and water for 10 to 100 minutes based upon the chip thickness. The solution is then cooled to about 98 degrees for bacterial action and about 80 degrees for fermentation. A yeast starter culture or bacterial liquor of 2% of the total water volume is added to the chip/water mix and left for several days until visible activity has ceased. The entire solution is again raised to a boil to kill the bacteria. The yeast solution can be used for bamboo food products if proper sanitation is followed. Otherwise, the entire solution should be raised to a boil to kill the yeast. The solutions are discarded or used and the chips rinsed. Bacterial action may discolor the bamboo.

A dilute basic chemical solution of under 5% potassium hydroxide or hydrochloric acid for a few hours depending upon the size and type of chips used, will soften the bamboo chips by basic chemical reaction. Care must be taken, however, if the chips are left in too long, the hydroxide will break down the fibers themselves and weaken the final product. The chips must be soaked and rinsed to remove the residual chemicals. The basic chemical process is cheap and quick but produces industrial waste and discolors the bamboo.

Boiling for several hours in a salt solution will also soften the chips. The time required for softening depends upon the chip thickness.

The resulting chips of the above softening processes are then dried to under 12% humidity, and coated with glue.

Hot glue may be used in combination after any of the above softening processes to further soften the chips. Alternatively, the use of hot glue may be substituted for the above softening processes when chips of under ⅛″ in thickness are used.

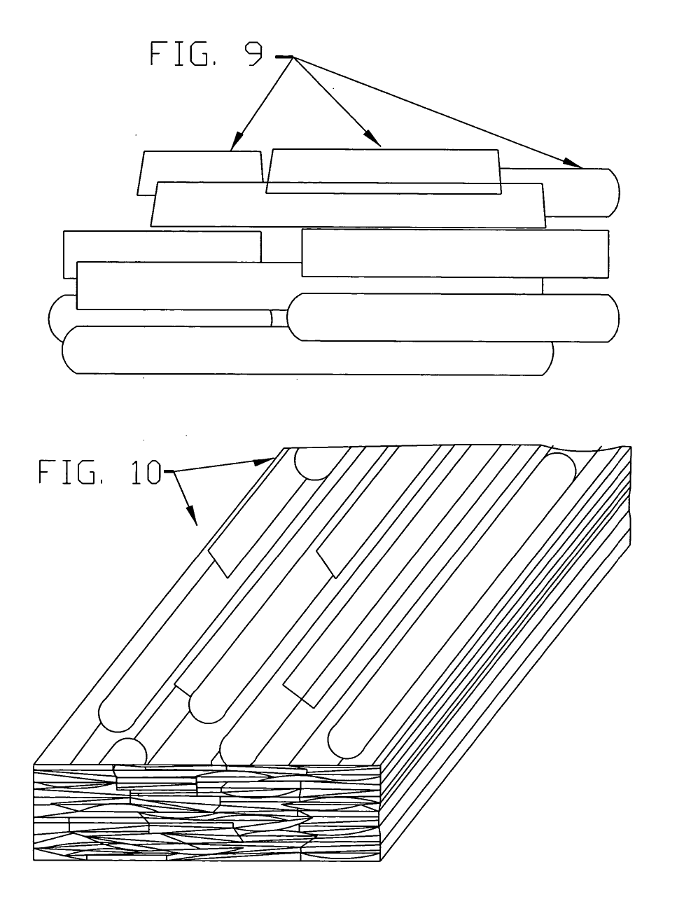

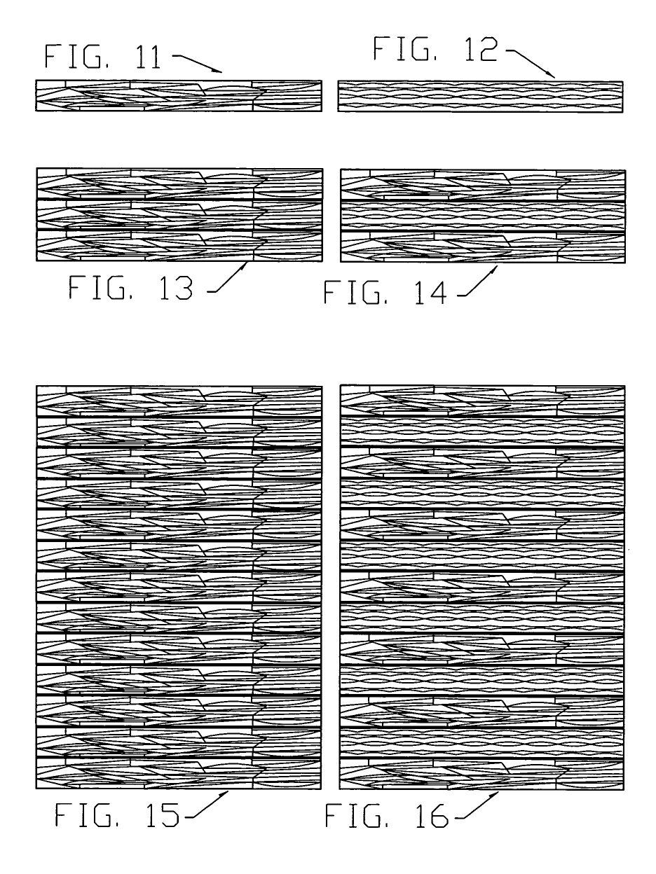

The glue coated chip fibers are generally oriented longitudinally parallel to the length of the form and laid on top of each other in a random overlapping manner as in FIG. 9. Because the chips are thin and bendable, the glue is evenly distributed and void spacing is low. When the chips are joined together with glue under pressure in a form, the result is that there is great coherence between the chips. The chips are compressed downwardly and perpendicular against the supporting surface, with the edges of the bed restrained so that a rectangular bamboo beam or board is formed with higher density and flatness in the outer layers of the board. A second pressing along the edges can be performed for pieces requiring a more finished appearance. FIG. 10 shows an isometric view of a board formed by this method. By varying the depth and length of the chips and the form size, the member produced can form a board, chipboard, beams, or columns of any size. FIG. 11 shows an end view of a board formed by this method that is thinner than the end view of the board shown in FIG. 10.

A wider form may be used to form a sheet of bamboo chipboard rather than a beam. FIG. 17 shows a bamboo chipboard end view with the chip strands generally oriented in parallel to the length of the board.

Bamboo chips may be arranged before pressing at great angles to the form so the chips are predominantly oriented perpendicular to the length of the form. Varying size boards, beams, columns, and chipboard may be produced as mentioned above. FIG. 18 shows a bamboo chipboard end view with the chip strands generally oriented perpendicular to the length of the board. FIG. 12 shows a bamboo board end view with the chip strands generally oriented perpendicular to the length of the board.

Once complete, additional bamboo boards may be produced and glued together under pressure in a form, with the result that there is great coherence between the board layers to form a bamboo beam or column. Various board dimensions can be fabricated to form bamboo beams or columns in any dimension. FIG. 13 shows a bamboo end view board, column, or beam formed by three layers of boards glued together where each bamboo boards' chip strands are generally oriented parallel to the length of the board. FIG. 15 shows a larger bamboo end view board, column, or beam formed by many layers of boards glued together where each boards chip strands are generally oriented parallel to the length of the board. FIG. 14 shows a bamboo end view board, column, or beam formed by three layers of boards glued together where the two outside bamboo boards chip strands are generally oriented parallel to the length of the board and the middle bamboo board is has the chip strands generally oriented perpendicular to the length of the board.

FIG. 16 shows a bamboo end view board, column, or beam formed by many layers of bamboo boards glued together wherein the first bamboo board's chip strands are generally orientated parallel to the board length, the second bamboo board's chip strands are generally orientated perpendicular to the first, and then each additional boards chip's orientation is perpendicular to the next.

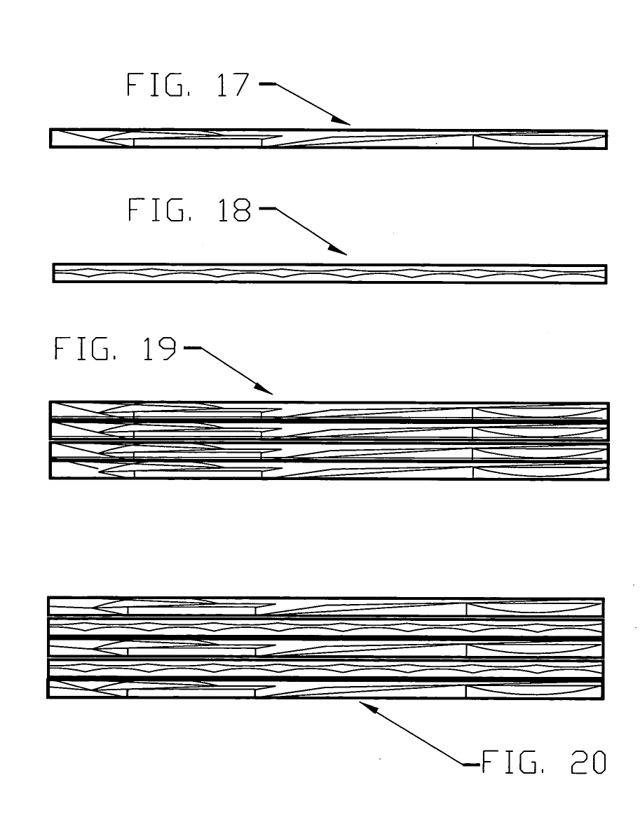

If several bamboo chipboard layers are fabricated in large sheets and glued together under pressure in a form, one can form ‘multi-ply bamboo’, which is a bamboo substitute for plywood. FIG. 19 shows a multi-ply bamboo end view formed by many layers of chipboards glued together where each boards chip strands are generally oriented parallel to the length of the board. FIG. 20 shows multi-ply bamboo end view formed by many layers of chipboards glued together wherein the first bamboo chipboard's chip strands are generally orientated parallel to the chipboard length, the second bamboo chipboard's chip strands are generally orientated perpendicular to the first, and then each additional bamboo chipboards chip strands are generally orientated perpendicular to the next.

Once the glue is cured, the resulting board, beam, column, or multi-ply bamboo member is kiln dried to below 12% humidity and sealed for moisture. Since this board, beam, column or multi-ply bamboo is sealed and the chips are softened, the strength will be consistent and the geometrical form stable such that it may be used in furniture or as structural grade members for frames and in residential, commercial, and industrial buildings.

The bamboo chip softening may be omitted, for economic reasons, in the above processes. The resulting members will still be strong, although not as strong and consistent as when chip softening occurs. These members could be used when strength and stability are not critical.

1. A process for fabricating bamboo chips suitable for structural use, wherein the bamboo shoot is cut into pieces under 6″ in length and then one splits the shoot lengthways, many times parallel to its length to produce thin bamboo chips of under ⅛″ in thickness, when the shoot is split radially, the chip width is the thickness of the bamboo shoot wall; and when the shoot is split vertically and horizontally, the maximum width used is ¾″, maximum thickness of ⅛″, then, the bamboo chips are softened and the chips dried to less than 12% humidity.

2. The process as claimed in claim 1 wherein said step of chips softening comprises exposing the bamboo chips to any combination of the following treatments:
I. oxidation by chlorine or chlorine byproducts in water, rinsed, then dried to less than 12% humidity and coated with glue
II. chemical reaction by hydrochloric acid or potassium hydroxide and water, rinsed, then dried to less than 12% humidity and coated with glue.
III. fermentation via yeast in warm water followed by boiling, rinsed, then dried to less than 12% humidity and coated with glue
IV. biological reduction via bacterial liquor in warm water followed by boiling, rinsed, then dried to less than 12% humidity and coated with glue
V. boiling in salt solution, rinsed, then dried to less than 12% humidity and coated with glue.
VI. coating chips with hot glue

3. The method as defined in claim 2, wherein the glue coated chips are located on top of each other in a random overlapping manner, wherein the chips are joined together with glue under pressure in a form, with the result that there is great coherence between and within the chips to form a bamboo board; then once the glue is cured, the resulting board is kiln dried to below 12% humidity and sealed for moisture, therefor boards of various thickness may be produced with this method depending upon the initial chip form depth and chip form width of chips compressed and glued, and furthermore, laminate of any material may be glued to the exterior surface of the board for improved appearance.

4. The method as defined in claim 2, wherein a board produced by claim 3 has its the chip strands generally oriented parallel to the length of the form, to form a bamboo board, chipboard, beam, or column.

5. The method as defined in claim 2, wherein a board produced by claim 3 has its the chip strands generally oriented perpendicular to the length of the form, to form a bamboo board, chipboard, beam, or column.

6. The method as defined in claim 2, wherein a board produced by claim 3 has its the chip strands generally oriented at any angle to the length of the form, to form a bamboo board, chipboard, beam, or column.

7. The method as defined in claim 2, wherein a board produced by claim 3 has its the chip strands oriented randomly to the other strands in the form, to form a bamboo board, chipboard, beam, or column.

8. The method as defined in claim 2, wherein several boards produced by claim 3 may be produced, with the chip strands generally oriented parallel to the length of the form, and glued together under pressure in a form, with the result that there is great coherence between the board layers to form a thicker bamboo member, wherein various board dimensions can be fabricated and glued together to form large bamboo members in any dimension, and once the glue is cured, the resulting larger board, beam, or column is kiln dried to below 12% humidity and sealed for moisture, and furthermore, laminate of any material may be glued to the exterior surface of the member for improved appearance.

9. The method as defined in claim 2, wherein several boards produced by claim 3 may be produced and glued together under pressure in a form, with the result that there is great coherence between the board layers to form a thicker bamboo member, wherein the first board's chip strands are generally orientated parallel to the board length, the second board's chip strands are generally orientated perpendicular to the first, and then each additional boards chip's orientation is perpendicular to the next, therefor, various board dimensions can be fabricated and glued together to form large bamboo members in any dimension, and once the glue is cured, the resulting member is kiln dried to below 12% humidity and sealed for moisture and furthermore, laminate of any material may be glued to the exterior surface of the member for improved appearance.

10. The method as defined in claim 2, wherein several boards produced by claim 3 may be produced and glued together under pressure in a form, with the result that there is great coherence between the board layers to form a thicker bamboo member, wherein the first board's chip strands are generally orientated parallel to the board length, the second board's chip strands are generally orientated at a large angle to the first, the third board's chip strands are generally orientated parallel to the board length, the next board's chip strands are generally orientated at a large angle to the previous, and then each additional layer continues to alternate with the next, therefor, various board dimensions can be fabricated and glued together to form large bamboo members in any dimension, and once the glue is cured, the resulting larger board, beam, or column is kiln dried to below 12% humidity and sealed for moisture, and furthermore, laminate of any material may be glued to the exterior surface of the member for improved appearance.

11. The method as defined in claim 2, wherein several boards produced by claim 3 may be produced and glued together under pressure in a form, with the result that there is great coherence between the board layers to form a thicker bamboo member, wherein the first board's chip strands are generally orientated parallel to the board length, the second board's chip strands are generally orientated at a large angle to the first, the third board's chip strands are generally orientated parallel to the board length, the next board's chip strands are orientated at any angle to the previous, and then each additional layer continues to alternate with the next, therefor, various board dimensions can be fabricated and glued together to form large bamboo members in any dimension, and once the glue is cured, the resulting larger board, beam, or column is kiln dried to below 12% humidity and sealed for moisture, and furthermore, laminate of any material may be glued to the exterior surface of the member for improved appearance.

12. The method as defined in claim 2, wherein several boards produced by claim 3 may be produced and glued together under pressure in a form, with the result that there is great coherence between the board layers to form a thicker bamboo member, wherein the two exterior board's chip strands are generally orientated parallel to the board length, and each interior board's chip strands are generally orientated at a large angle to the board length, thereby various board dimensions can be fabricated and glued together to form large bamboo columns in any dimension, and once the glue is cured, the resulting larger board, beam, or column is kiln dried to below 12% humidity and sealed for moisture, furthermore, laminate of any material may be glued to the exterior surface of the member for improved appearance.

13. The method as defined in claim 2, wherein several boards produced by claim 3 may be produced and glued together under pressure in a form, with the result that there is great coherence between the board layers to form a thicker bamboo member, wherein the two exterior board's chip strands are generally orientated parallel to the board length, and each interior board's chip strands are generally orientated perpendicular to the board length, thereby various board dimensions can be fabricated and glued together to form large bamboo columns in any dimension, and once the glue is cured, the resulting larger board, beam, or column is kiln dried to below 12% humidity and sealed for moisture, furthermore, laminate of any material may be glued to the exterior surface of the member for improved appearance.

14. The method as defined in claim 2, wherein several boards produced by claim 3 may be produced and glued together under pressure in a form, with the result that there is great coherence between the board layers to form a thicker bamboo member, wherein the two exterior board's chip strands are generally orientated parallel to the board length, and each interior board's chip strands are generally orientated at any angle to the board length, thereby various board dimensions can be fabricated and glued together to form large bamboo columns in any dimension, and once the glue is cured, the resulting larger board, beam, or column is kiln dried to below 12% humidity and sealed for moisture, furthermore, laminate of any material may be glued to the exterior surface of the member for improved appearance.

15. The method as defined in claim 3, wherein using a wide form, large sheets of bamboo chipboard are formed. Once the glue is cured, the resulting multi-ply bamboo is kiln dried to below 12% humidity and sealed for moisture.

16. The method as defined in claim 3, wherein using a wide form, large sheets of bamboo chipboard are formed, and once this first large chipboard is complete, having major and minor surfaces, several chipboard layers of matching dimensions are fabricated in large sheets, whereby each major surface of each board is glued to the next major surface of the next chipboard under pressure in a form, to form a thicker chipboard as ‘multi-ply bamboo’, which is a bamboo substitute for plywood, wherein the fibers of each chipboard are oriented at any angle and once the glue is cured, the resulting multi-ply bamboo is kiln dried to below 12% humidity and sealed for moisture, furthermore, laminate of any material may be glued to the exterior surface of the column for improved appearance.

17. The method as defined in claim 3, wherein using a wide form, large sheets of bamboo chipboard are formed, and once this first large chipboard is complete, having major and minor surfaces, several chipboard layers of matching dimensions are fabricated in large sheets , whereby each major surface of each board is glued to the next major surface of the next chipboard under pressure in a form, to form a thicker chipboard as ‘multi-ply bamboo’, which is a bamboo substitute for plywood, furthermore, the first board's chip strands are generally orientated parallel to the board length, the second board's chip strands are generally orientated perpendicular to the first, and then each additional boards chip's orientation is perpendicular to the next, and, once the glue is cured, the resulting multi-ply bamboo is kiln dried to below 12% humidity and sealed for moisture, furthermore, laminate of any material may be glued to the exterior surface of the column for improved appearance.

18. The method as defined in claim 3, wherein using a wide form, large sheets of bamboo chipboard are formed, where, once this first large chipboard is complete, having major and minor surfaces, several chipboard layers of matching dimensions are fabricated in large sheets , where each major surface of each board is glued to the next major surface of the next chipboard under pressure in a form, to form a thicker chipboard as ‘multi-ply bamboo’, which is a bamboo substitute for plywood, furthermore, the first board's chip strands are generally orientated parallel to the board length, the second board's chip strands are generally orientated at a large angle to the first, the third board's chip strands are generally orientated parallel to the board length, the next board's chip strands are generally orientated at a large angle to the previous, and then each additional layer continues to alternates with the next, and once the glue is cured, the resulting multi-ply bamboo is kiln dried to below 12% humidity and sealed for moisture, furthermore, laminate of any material may be glued to the exterior surface of the column for improved appearance.

19. The method as defined in claim 3, wherein using a wide form, large sheets of bamboo chipboard are formed, and once this first large chipboard is complete, having major and minor surfaces, several chipboard layers of matching dimensions are fabricated in large sheets , where each major surface of each board is glued to the next major surface of the next chipboard under pressure in a form, to form a thicker chipboard as ‘multi-ply bamboo’, which is a bamboo substitute for plywood, wherein the two outer chipboard's chip strands are generally orientated parallel to the board length, and the interior chipboard's chip strands are generally orientated perpendicular to each interior board's length, and once the glue is cured, the resulting multi-ply bamboo is kiln dried to below 12% humidity and sealed for moisture, furthermore, laminate of any material may be glued to the exterior surface of the column for improved appearance.

20. The method as defined in claim 3, wherein using a wide form, large sheets of bamboo chipboard are formed, and once this first large chipboard is complete, having major and minor surfaces, several chipboard layers of matching dimensions are fabricated in large sheets , where each major surface of each board is glued to the next major surface of the next chipboard under pressure in a form, to form a thicker chipboard as ‘multi-ply bamboo’, which is a bamboo substitute for plywood, wherein the two exterior board's chip strands are generally orientated parallel to the board length, and each interior board's chip strands are generally orientated at a large angle to the board length, and once the glue is cured, the resulting multi-ply bamboo is kiln dried to below 12% humidity and sealed for moisture, furthermore, laminate of any material may be glued to the exterior surface of the column for improved appearance.

21. The method as defined in claim 3, wherein using a wide form, large sheets of bamboo chipboard are formed, and once this first large chipboard is complete, having major and minor surfaces, several chipboard layers of matching dimensions are fabricated in large sheets, where each major surface of each board is glued to the next major surface of the next chipboard under pressure in a form, to form a thicker chipboard as ‘multi-ply bamboo’, which is a bamboo substitute for plywood, wherein the two exterior board's chip strands are generally orientated parallel to the board length, and each interior board's chip strands are orientated at any angle to the board length, and once the glue is cured, the resulting multi-ply bamboo is kiln dried to below 12% humidity and sealed for moisture, furthermore, laminate of any material may be glued to the exterior surface of the column for improved appearance.

22. The method as defined in claim 3, wherein using a wide form, large sheets of bamboo chipboard are formed, and once this first large chipboard is complete, having major and minor surfaces, several chipboard layers of matching dimensions are fabricated in large sheets , where each major surface of each board is glued to the next major surface of the next chipboard under pressure in a form, to form a thicker chipboard as ‘multi-ply bamboo’, which is a bamboo substitute for plywood, wherein the two exterior board's chip strands are generally orientated parallel to the board length, and each interior board's chip strands are also generally orientated parallel to the board length, and once the glue is cured, the resulting multi-ply bamboo is kiln dried to below 12% humidity and sealed for moisture, furthermore, laminate of any material may be glued to the exterior surface of the column for improved appearance.

23. A process for fabricating bamboo chips suitable for structural use, wherein the bamboo shoot is fed through a rotating blade machine and cut into many thin separate bamboo lengths of under ⅛″ in thickness, then the bamboo lengths are cut to form chips of under 6″ in length, softened, and then the bamboo chips are dried to less than 12% humidity.

24. The process as claimed in claim 23 wherein said step of chips softening comprises exposing the bamboo chips to any combination of the following treatments:
I. oxidation by chlorine or chlorine byproducts in water, rinsed, then dried to less than 12% humidity and coated with glue
II. chemical reaction by hydrochloric acid or potassium hydroxide and water, rinsed, then dried to less than 12% humidity and coated with glue.
III. fermentation via yeast in warm water followed by boiling, rinsed, then dried to less than 12% humidity and coated with glue
IV. biological reduction via bacterial liquor in warm water followed by boiling, rinsed, then dried to less than 12% humidity and coated with glue
V. boiling in salt solution, rinsed, then dried to less than 12% humidity and coated with glue.
VI. coating chips with hot glue

25. The method as defined in claim 24, wherein the glue coated chips are located on top of each other in a random overlapping manner, wherein the chips are joined together with glue under pressure in a form, with the result that there is great coherence between and within the chips to form a bamboo board; then once the glue is cured, the resulting member is kiln dried to below 12% humidity and sealed for moisture, therefor boards of various thickness may be produced with this method depending upon the initial depth of chips compressed and glued, and furthermore, laminate of any material may be glued to the exterior surface of the board for improved appearance.

26. The method as defined in claim 24, wherein a board produced by claim 25 has its the chip strands generally oriented parallel to the length of the form, to form a bamboo board, chipboard, beam, or column.

27. The method as defined in claim 24, wherein a board produced by claim 25 has its the chip strands generally oriented perpendicular to the length of the form, to form a bamboo board, chipboard, beam, or column.

28. The method as defined in claim 24, wherein a board produced by claim 25 has its the chip strands oriented at any angle to the length of the form, to form a bamboo board, chipboard, beam, or column.

29. The method as defined in claim 24, wherein a board produced by claim 25 has its the chip strands oriented randomly to the other strands in the form, to form a bamboo board, chipboard, beam, or column.

30. The method as defined in claim 24, wherein several boards by claim 25 may be produced, whereby the boards chip strands being generally oriented parallel to the length of the form, and glued together under pressure in a form, with the result that there is great coherence between the board layers to form a thicker bamboo member, thereby various board dimensions can be fabricated and glued together to form large bamboo larger board, beam, or columns in any dimension, and once the glue is cured, the resulting member is kiln dried to below 12% humidity and sealed for moisture.

31. The method as defined in claim 24, wherein several boards produced by claim 25 may be produced and glued together under pressure in a form, with the result that there is great coherence between the board layers to form a thicker bamboo member, wherein the first board's chip strands are generally orientated parallel to the board length, the second board's chip strands are generally orientated perpendicular to the first, and then each additional boards chip's orientation is perpendicular to the next, thereby, various board dimensions can be fabricated and glued together to form large bamboo larger board, beam, or columns in any dimension, and once the glue is cured, the resulting member is kiln dried to below 12% humidity and sealed for moisture, furthermore, the laminate of any material may be glued to the exterior surface of the member for improved appearance.

32. The method as defined in claim 24, wherein several boards produced by claim 25 may be produced and glued together under pressure in a form, with the result that there is great coherence between the board layers to form a thicker bamboo member, wherein the first board's chip strands are generally orientated parallel to the board length, the second board's chip strands are generally orientated at a large angle to the first, the third board's chip strands are generally orientated parallel to the board length, the next board's chip strands are generally orientated at a large angle to the previous, and then each additional layer continues to alternate with the next, thereby, various board dimensions can be fabricated and glued together to form large bamboo members in any dimension and once the glue is cured, the resulting larger board, beam, or column is kiln dried to below 12% humidity and sealed for moisture, furthermore, the laminate of any material may be glued to the exterior surface of the member for improved appearance.

33. The method as defined in claim 24, wherein several boards produced by claim 25 may be produced and glued together under pressure in a form, with the result that there is great coherence between the board layers to form a thicker bamboo member, wherein the two exterior board's chip strands are generally orientated parallel to the board length, and each interior board's chip strands are generally orientated at a large angle to the board length, thereby various board dimensions can be fabricated and glued together to form large bamboo columns in any dimension, and once the glue is cured, the resulting larger board, beam, or column is kiln dried to below 12% humidity and sealed for moisture, furthermore, laminate of any material may be glued to the exterior surface of the member for improved appearance.

34. The method as defined in claim 24, wherein several boards produced by claim 25 may be produced and glued together under pressure in a form, with the result that there is great coherence between the board layers to form a thicker bamboo member, wherein the two exterior board's chip strands are generally orientated parallel to the board length, and each interior board's chip strands are generally orientated perpendicular to the board length, thereby various board dimensions can be fabricated and glued together to form large bamboo columns in any dimension, and once the glue is cured, the resulting larger board, beam, or column is kiln dried to below 12% humidity and sealed for moisture, furthermore, laminate of any material may be glued to the exterior surface of the member for improved appearance.

35. The method as defined in claim 24, wherein several boards produced by claim 25 may be produced and glued together under pressure in a form, with the result that there is great coherence between the board layers to form a thicker bamboo member, wherein the two exterior board's chip strands are generally orientated parallel to the board length, and each interior board's chip strands are orientated at any angle to the board length, thereby various board dimensions can be fabricated and glued together to form large bamboo columns in any dimension, and once the glue is cured, the resulting larger board, beam, or column is kiln dried to below 12% humidity and sealed for moisture, furthermore, laminate of any material may be glued to the exterior surface of the member for improved appearance.

36. The method as defined in claim 25, wherein using a wide form, large sheets of bamboo chipboard are formed, and once this first large chipboard is complete, having major and minor surfaces, several chipboard layers of matching dimensions are fabricated in large sheets, whereby each major surface of each board is glued to the next major surface of the next chipboard under pressure in a form, to form a thicker chipboard as ‘multi-ply bamboo’, which is a bamboo substitute for plywood, wherein the fibers of each chipboard are generally oriented at any angle and once the glue is cured, the resulting multi-ply bamboo is kiln dried to below 12% humidity and sealed for moisture, furthermore, laminate of any material may be glued to the exterior surface of the column for improved appearance.

37. The method as defined in claim 25, wherein using a wide form, large sheets of bamboo chipboard are formed, and once this first large chipboard is complete, having major and minor surfaces, several chipboard layers of matching dimensions are fabricated in large sheets, whereby each major surface of each board is glued to the next major surface of the next chipboard under pressure in a form, to form a thicker chipboard as ‘multi-ply bamboo’, which is a bamboo substitute for plywood, furthermore, the first board's chip strands are generally orientated parallel to the board length, the second board's chip strands are generally orientated perpendicular to the first, and then each additional boards chip's orientation is perpendicular to the next, and, once the glue is cured, the resulting multi-ply bamboo is kiln dried to below 12% humidity and sealed for moisture, furthermore, laminate of any material may be glued to the exterior surface of the column for improved appearance.

38. The method as defined in claim 25, wherein using a wide form, large sheets of bamboo chipboard are formed, where, once this first large chipboard is complete, having major and minor surfaces, several chipboard layers of matching dimensions are fabricated in large sheets, where each major surface of each board is glued to the next major surface of the next chipboard under pressure in a form, to form a thicker chipboard as ‘multi-ply bamboo’, which is a bamboo substitute for plywood, furthermore, the first board's chip strands are generally orientated parallel to the board length, the second board's chip strands are generally orientated at a large angle to the first, the third board's chip strands are generally orientated parallel to the board length, the next board's chip strands are generally orientated at a large angle to the previous, and then each additional layer continues to alternates with the next, and once the glue is cured, the resulting multi-ply bamboo is kiln dried to below 12% humidity and sealed for moisture, furthermore, laminate of any material may be glued to the exterior surface of the column for improved appearance.

39. The method as defined in claim 25, wherein using a wide form, large sheets of bamboo chipboard are formed, and once this first large chipboard is complete, having major and minor surfaces, several chipboard layers of matching dimensions are fabricated in large sheets, where each major surface of each board is glued to the next major surface of the next chipboard under pressure in a form, to form a thicker chipboard as ‘multi-ply bamboo’, which is a bamboo substitute for plywood, wherein the two outer chipboard's chip strands are generally orientated parallel to the board length, and the interior chipboard's chip strands are generally orientated perpendicular to each interior board's length, and once the glue is cured, the resulting multi-ply bamboo is kiln dried to below 12% humidity and sealed for moisture, furthermore, laminate of any material may be glued to the exterior surface of the column for improved appearance.

40. The method as defined in claim 25, wherein using a wide form, large sheets of bamboo chipboard are formed, and once this first large chipboard is complete, having major and minor surfaces, several chipboard layers of matching dimensions are fabricated in large sheets, where each major surface of each board is glued to the next major surface of the next chipboard under pressure in a form, to form a thicker chipboard as ‘multi-ply bamboo’, which is a bamboo substitute for plywood, wherein the two exterior board's chip strands are generally orientated parallel to the board length, and each interior board's chip strands are generally orientated at a large angle to the board length, and once the glue is cured, the resulting multi-ply bamboo is kiln dried to below 12% humidity and sealed for moisture, furthermore, laminate of any material may be glued to the exterior surface of the column for improved appearance.

41. The method as defined in claim 25, wherein using a wide form, large sheets of bamboo chipboard are formed, and once this first large chipboard is complete, having major and minor surfaces, several chipboard layers of matching dimensions are fabricated in large sheets , where each major surface of each board is glued to the next major surface of the next chipboard under pressure in a form, to form a thicker chipboard as ‘multi-ply bamboo’, which is a bamboo substitute for plywood, wherein the two exterior board's chip strands are generally orientated parallel to the board length, and each interior board's chip strands are orientated at any angle to the board length, and once the glue is cured, the resulting multi-ply bamboo is kiln dried to below 12% humidity and sealed for moisture, furthermore, laminate of any material may be glued to the exterior surface of the column for improved appearance.

42. The method as defined in claim 25, wherein using a wide form, large sheets of bamboo chipboard are formed, and once this first large chipboard is complete, having major and minor surfaces, several chipboard layers of matching dimensions are fabricated in large sheets , where each major surface of each board is glued to the next major surface of the next chipboard under pressure in a form, to form a thicker chipboard as ‘multi-ply bamboo’, which is a bamboo substitute for plywood, wherein the two exterior board's chip strands are generally orientated parallel to the board length, and each interior board's chip strands are also generally generally orientated parallel to the board length, and once the glue is cured, the resulting multi-ply bamboo is kiln dried to below 12% humidity and sealed for moisture, furthermore, laminate of any material may be glued to the exterior surface of the column for improved appearance.

43. A process for fabricating bamboo chips suitable for structural use, wherein the bamboo shoot may be cut into pieces under 6″ in length, and then one splits the shoot lengthways, many times, parallel to its length to produce thin bamboo chips of under ⅛″ in thickness, when the shoot is split radially, the chip width is the thickness of the bamboo shoot wall; and when the shoot is split vertically and horizontally, the maximum width used is ¾″, then the bamboo chips from either method are dried to less than 12% humidity, wherein the resulting chips are coated with glue and then the chips are located on top of each other in a random overlapping manner, wherein the chips are joined together with glue under pressure in a form, with the result that there is great coherence between and within the chips to form a bamboo board, beam, column, or chipboard, whereby members of various dimensions may be produced with this method depending upon the initial depth and width of chips compressed and glued in the form, and furthermore, the resulting member is kiln dried to below 12% humidity and sealed for moisture.

44. The method as defined in claim 43, wherein a board produced has its the chip strands generally oriented parallel to the length of the form, to form a bamboo board, chipboard, beam, or column.

45. The method as defined in claim 43, wherein a board produced has its the chip strands generally oriented perpendicular to the length of the form, to form a bamboo board, chipboard, beam, or column.

46. The method as defined in claim 43, wherein a board produced has its the chip strands oriented at any angle to the length of the form, to form a bamboo board, chipboard, beam, or column.

47. The method as defined in claim 43, wherein a board produced has its the chip strands oriented randomly to the other strands in the form, to form a bamboo board, chipboard, beam, or column.

48. The method as defined in claim 43, wherein several boards produced by claim 43 may be produced and glued together under pressure in a form, with the result that there is great coherence between the board layers to form a thicker bamboo member, wherein the two exterior board's chip strands are generally orientated parallel to the board length, and each interior board's chip strands are orientated at any angle to the board length, thereby various board dimensions can be fabricated and glued together to form large bamboo members in any dimension, and once the glue is cured, the resulting larger board, beam, or column is kiln dried to below 12% humidity and sealed for moisture, furthermore, laminate of any material may be glued to the exterior surface of the member for improved appearance.

49. The method as defined in claim 43, wherein using a wide form, large sheets of bamboo chipboard are formed, and once this first large chipboard is complete, having major and minor surfaces, several chipboard layers of matching dimensions are fabricated in large sheets, where each major surface of each board is glued to the next major surface of the next chipboard under pressure in a form, to form a thicker chipboard as ‘multi-ply bamboo’, which is a bamboo substitute for plywood, wherein the two exterior board's chip strands are generally orientated parallel to the board length, and each interior board's chip strands are orientated at a any angle to the board length, and once the glue is cured, the resulting multi-ply bamboo is kiln dried to below 12% humidity and sealed for moisture, furthermore, laminate of any material may be glued to the exterior surface of the column for improved appearance.

50. A process for fabricating bamboo chips suitable for structural use, wherein the bamboo shoot is fed through a rotating blade machine and cut into many thin separate bamboo lengths of under ⅛″ in thickness, the bamboo lengths are cut to form chips of under 6″ in length, and then, the chips are dried to less than 12% humidity, wherein the resulting chips are coated with glue and then the chips are located on top of each other in a random overlapping manner, wherein the chips are joined together with glue under pressure in a form, with the result that there is great coherence between and within the chips to form a bamboo board, beam, column, or chipboard, whereby members of various dimensions may be produced with this method depending upon the initial depth and width of chips compressed and glued in the form, and furthermore, the resulting member is kiln dried to below 12% humidity and sealed for moisture, furthermore, laminate of any material may be glued to the exterior surface of the column for improved appearance.

51. The method as defined in claim 50, wherein a board produced has its the chip strands generally oriented parallel to the length of the form, to form a bamboo board, chipboard, beam, or column.

52. The method as defined in claim 50, wherein a board produced has its the chip strands generally oriented perpendicular to the length of the form, to form a bamboo board, chipboard, beam, or column.

53. The method as defined in claim 50, wherein a board produced has its the chip strands oriented at any angle to the length of the form, to form a bamboo board, chipboard, beam, or column.

54. The method as defined in claim 50, wherein a board produced has its the chip strands oriented randomly to the other strands in the form, to form a bamboo board, chipboard, beam, or column.

55. The method as defined in claim 50, wherein several boards produced by claim 50 may be produced and glued together under pressure in a form, with the result that there is great coherence between the board layers to form a thicker bamboo member, wherein the two exterior board's chip strands are generally orientated parallel to the board length, and each interior board's chip strands are orientated at any angle to the board length, thereby various board dimensions can be fabricated and glued together to form large bamboo members in any dimension, and once the glue is cured, the resulting larger board, beam, or column is kiln dried to below 12% humidity and sealed for moisture, furthermore, laminate of any material may be glued to the exterior surface of the member for improved appearance.

56. The method as defined in claim 50, wherein using a wide form, large sheets of bamboo chipboard are formed, and once this first large chipboard is complete, having major and minor surfaces, several chipboard layers of matching dimensions are fabricated in large sheets , where each major surface of each board is glued to the next major surface of the next chipboard under pressure in a form, to form a thicker chipboard as ‘multi-ply bamboo’, which is a bamboo substitute for plywood, wherein the two exterior board's chip strands are generally orientated parallel to the board length, and each interior board's chip strands are orientated at a any angle to the board length, and once the glue is cured, the resulting multi-ply bamboo is kiln dried to below 12% humidity and sealed for moisture, furthermore, laminate of any material may be glued to the exterior surface of the column for improved appearance.
